(19) United States
(12) Patent Application Publication
(10) Pub. No.: US 2013/0048113 A1
(43) Pub. Date: Feb. 28, 2013

(54) SYSTEMS AND METHODS FOR PREVENTING USERS TO DISPOSE IMPROPER WASTE INTO SEWAGE SYSTEMS

(71) Applicant: MAN LOK, Hong Kong (HK)

(72) Inventor: MAN LOK, Hong Kong (HK)

(21) Appl. No.: 13/217,684

(22) Filed: Aug. 25, 2011

(51) Int. Cl. F16K 37/00

(52) U.S. Cl. 137/551

(57) ABSTRACT

A sea filtration system is provided for preventing users to dispose improper waste into sewage systems. In one embodiment, a sea filtration system includes a sewage system, a camera mounted outside a toilet room, wherein the camera is configured to capture a wrongful act by the user by capturing a face of a user after the user leaving the toilet room when industrial waste is detected, a toilet connecting to the sewage system, a computer server connecting to the toilet, a compartment in the toilet, when flushed, hold on to the industrial waste without flushing into the sewage system, a blockage sensor, an industrial waste sensor configured to detect if industrial waste is being flushed, and a toxic waste sensor configured to detect if toxic waste is being flushed.

### FIELD OF THE INVENTION

This invention generally relates to sea filtration systems for preventing users to dispose improper waste into sewage systems. In one embodiment, a system is provided for detecting that the user has attempted to dispose certain matter into the toilet, detecting that the user has attempted to flush the toilet, detecting that the certain matter being flushed includes industrial waste, blocking the certain matter from being flushed into the sewage system, allowing the certain matter to be flowed into the compartment in the toilet, and taking a picture of the user when the user is leaving the toilet room, and sending an alert to a third party to report the wrongful act, wherein the alert includes evidence of accusation of the wrongful act, the evidence including the picture of the user and the detected certain matter being flushed by the user.

### BACKGROUND OF THE INVENTION

Industrial waste is toxic waste material that can cause death or injury to living creatures. It spreads quite easily and can contaminate lakes and rivers. In many countries, government regulation requires that toxic waste be handled with special precautions and be disposed of in designated facilities around the country. Also, many cities have collection days where household toxic waste is gathered. Some materials that are unaccepted at regular landfills are ammunition, commercially generated waste, explosives, shock sensitive items, hypodermic needles, syringes, medical waste, radioactive materials, smoke detectors, trash, recyclables, and unknown materials. Usually, toxic waste facilities are used to store waste underground in sealed containers to make sure these dangerous materials can be stored safely without contaminating rivers or sea. The problem is, handling toxic waste with care costs money. In some cases, industrial waste is simply drained down to toilets. This waste would then drain down through the convention sewage system that carries only human waste into the sea. If this occurs, contamination to the sea would occur. There is therefore, a need to detect if improper use of human toilets has occurred.

### SUMMARY OF THE INVENTION

According to embodiments of the present invention, a sea filtration system is provided for preventing users to dispose industrial waste into sewage systems. The system may comprises a sewage system; a camera mounted outside a toilet room, wherein the camera is configured to capture a wrongful act by the user by capturing a face of a user after the user leaving the toilet room when industrial waste is detected; a toilet connecting to the sewage system; a computer server connecting to the toilet; a compartment in the toilet, when flushed, hold on to the industrial waste without flushing into the sewage system; a blockage sensor; an industrial waste sensor configured to detect if industrial waste is being flushed; a toxic waste sensor configured to detect if toxic waste is being flushed; a processor; and a memory storing instructions to cause the processor to execute a method, comprising: detecting that the user has attempted to dispose certain matter into the toilet; detecting that the user has attempted to flush the toilet; based on the industrial waste sensor, detecting that the certain matter being flushed includes industrial waste; blocking the certain matter from being flushed into the sewage system; allowing the certain matter to be flowed into the compartment in the toilet; taking a picture of the user when the user is leaving the toilet room; through the computer server, sending an alert to a third party to report the wrongful act, wherein the alert includes evidence of accusation of the wrongful act, the evidence including the picture of the user and the detected certain matter being flushed by the user; allowing the third party to examine the contained subject matter by releasing the compartment in the toilet for examination; allowing another user to use the toilet; and if the another user is attempting to flush the toilet with non-industrial waste, allowing the non-industrial waste to be flushed into the sewage system.

Further in the embodiments, the method may comprise detecting that the user has attempted to dispose certain matter into the toilet; detecting that the user has attempted to flush the toilet; based on the blockage sensor, detecting that the flow of water being flushed has slowed to a threshold point set previously; concluding that the certain matter being flushed by the user causes the blockage; blocking the certain matter from being flushed into the sewage system; allowing the certain matter to be flowed into the compartment in the toilet; taking a picture of the user when the user is leaving the toilet room; through the computer server, sending an alert to a third party to report the wrongful act, wherein the alert includes evidence of accusation of the wrongful act, the evidence including the picture of the user and the detected certain matter being flushed by the user; allowing the third party to examine the contained subject matter by releasing the compartment in the toilet for examination; and allowing another user to use the toilet.

Alternatively, the system may perform detecting that the user has attempted to dispose certain matter into the toilet; detecting that the user has attempted to flush the toilet; based on the blockage sensor, detecting that the flow of water being flushed has slowed to a threshold point set previously; concluding that the certain matter being flushed by the user causes the blockage; blocking the certain matter from being flushed into the sewage system; allowing the certain matter to be flowed into the second compartment in the toilet; taking a picture of the user when the user is leaving the toilet room; through the computer server, sending an alert to a third party to report the wrongful act, wherein the alert includes evidence of accusation of the wrongful act, the evidence including the picture of the user and the detected certain matter being flushed by the user; allowing the third party to examine the contained subject matter by releasing the second compartment in the toilet for examination; detecting that a second user has attempted to dispose certain matter into the toilet; detecting that the second user has attempted to flush the toilet; based on the industrial waste sensor, detecting that the certain matter being flushed includes industrial waste; blocking the certain matter from being flushed into the sewage system; allowing the certain matter to be flowed into the compartment in the toilet; taking a picture of the second user when the second user is leaving the toilet room; through the computer server, sending an alert to a third party to report the wrongful act, wherein the alert includes evidence of accusation of the wrongful act, the evidence including the picture of the second user and the detected certain matter being flushed by the second user; and allowing the third party to examine the contained subject matter by releasing the compartment in the toilet for examination.

### BRIEF DESCRIPTION OF THE DRAWINGS

FIG. 1 illustrates an exemplary system to prevent improper disposal of wastage.

### DETAILED DESCRIPTION

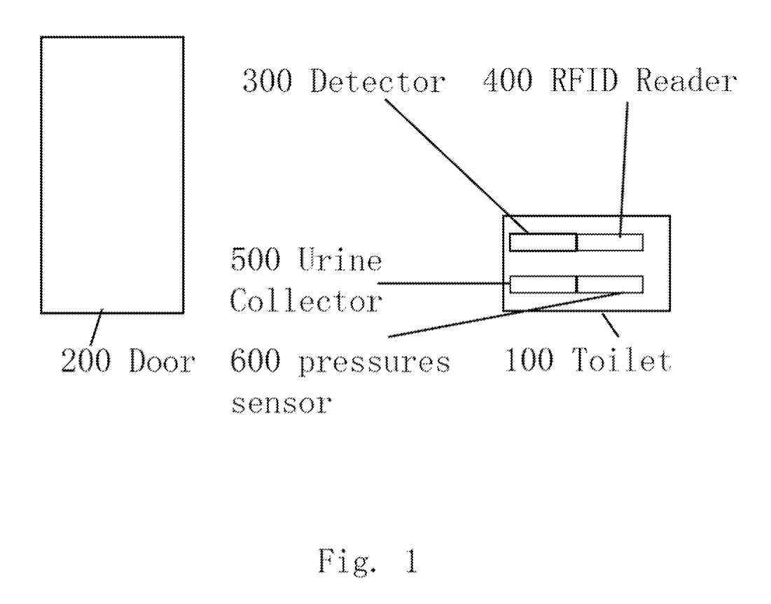

Different implementations may be used to implement the present invention. As an example, a sea filtration system is disclosed. The system may be used for preventing users to dispose industrial waste into sewage systems. Referring to FIG. 1, the present disclosed system comprises a sewage system; a camera mounted outside a toilet room, wherein the camera is configured to capture a wrongful act by the user by capturing a face of a user after the user leaving the toilet room when industrial waste is detected; a toilet connecting to the sewage system; a computer server connecting to the toilet; a compartment in the toilet, when flushed, hold on to the industrial waste without flushing into the sewage system; a blockage sensor; an industrial waste sensor configured to detect if industrial waste is being flushed; a toxic waste sensor configured to detect if toxic waste is being flushed; a processor; and a memory storing instructions to cause the processor to execute a method, comprising: detecting that the user has attempted to dispose certain matter into the toilet; detecting that the user has attempted to flush the toilet; based on the industrial waste sensor, detecting that the certain matter being flushed includes industrial waste; blocking the certain matter from being flushed into the sewage system; allowing the certain matter to be flowed into the compartment in the toilet; taking a picture of the user when the user is leaving the toilet room; through the computer server, sending an alert to a third party to report the wrongful act, wherein the alert includes evidence of accusation of the wrongful act, the evidence including the picture of the user and the detected certain matter being flushed by the user; allowing the third party to examine the contained subject matter by releasing the compartment in the toilet for examination; allowing another user to use the toilet; and if the another user is attempting to flush the toilet with non-industrial waste, allowing the non-industrial waste to be flushed into the sewage system.

In a different implementation, the sea filtration system for may comprises a sewage system; a camera mounted outside a toilet room, wherein the camera is configured to capture a wrongful act by the user by capturing a face of a user after the user leaving the toilet room when industrial waste is detected; a toilet connecting to the sewage system; a computer server connecting to the toilet; a compartment in the toilet, when flushed, hold on to the industrial waste without flushing into the sewage system; a blockage sensor; an industrial waste sensor configured to detect if industrial waste is being flushed; a toxic waste sensor configured to detect if toxic waste is being flushed; a processor; and a memory storing instructions to cause the processor to execute a method, comprising: detecting that the user has attempted to dispose certain matter into the toilet; detecting that the user has attempted to flush the toilet; based on the blockage sensor, detecting that the flow of water being flushed has slowed to a threshold point set previously; concluding that the certain matter being flushed by the user causes the blockage; blocking the certain matter from being flushed into the sewage system; allowing the certain matter to be flowed into the compartment in the toilet; taking a picture of the user when the user is leaving the toilet room; through the computer server, sending an alert to a third party to report the wrongful act, wherein the alert includes evidence of accusation of the wrongful act, the evidence including the picture of the user and the detected certain matter being flushed by the user; allowing the third party to examine the contained subject matter by releasing the compartment in the toilet for examination; and allowing another user to use the toilet.

The sea filtration system may be further modified for preventing users to dispose industrial waste into sewage systems, comprising: a sewage system; a camera mounted outside a toilet room, wherein the camera is configured to capture a wrongful act by the user by capturing a face of a user after the user leaving the toilet room when industrial waste is detected; a toilet connecting to the sewage system; a computer server connecting to the toilet; a first compartment in the toilet, when flushed, hold on to the industrial waste without flushing into the sewage system; a second compartment in the toilet to hold on subject matter when blockage occurs; a blockage sensor; an industrial waste sensor configured to detect if industrial waste is being flushed; a toxic waste sensor configured to detect if toxic waste is being flushed; a processor; and a memory storing instructions to cause the processor to execute a method, comprising: detecting that the user has attempted to dispose certain matter into the toilet; detecting that the user has attempted to flush the toilet; based on the blockage sensor, detecting that the flow of water being flushed has slowed to a threshold point set previously; concluding that the certain matter being flushed by the user causes the blockage; blocking the certain matter from being flushed into the sewage system; allowing the certain matter to be flowed into the second compartment in the toilet; taking a picture of the user when the user is leaving the toilet room; through the computer server, sending an alert to a third party to report the wrongful act, wherein the alert includes evidence of accusation of the wrongful act, the evidence including the picture of the user and the detected certain matter being flushed by the user; allowing the third party to examine the contained subject matter by releasing the second compartment in the toilet for examination; detecting that a second user has attempted to dispose certain matter into the toilet; detecting that the second user has attempted to flush the toilet; based on the industrial waste sensor, detecting that the certain matter being flushed includes industrial waste; blocking the certain matter from being flushed into the sewage system; allowing the certain matter to be flowed into the compartment in the toilet; taking a picture of the second user when the second user is leaving the toilet room; through the computer server, sending an alert to a third party to report the wrongful act, wherein the alert includes evidence of accusation of the wrongful act, the evidence including the picture of the second user and the detected certain matter being flushed by the second user; and allowing the third party to examine the contained subject matter by releasing the compartment in the toilet for examination.

What is claimed is:

1. A sea filtration system for preventing users to dispose industrial waste into sewage systems, comprising:
a sewage system;
a camera mounted outside a toilet room, wherein the camera is configured to capture a wrongful act by the user by capturing a face of a user after the user leaving the toilet room when industrial waste is detected;
a toilet connecting to the sewage system;
a computer server connecting to the toilet;
a compartment in the toilet, when flushed, hold on to the industrial waste without flushing into the sewage system;
a blockage sensor;
an industrial waste sensor configured to detect if industrial waste is being flushed;
a toxic waste sensor configured to detect if toxic waste is being flushed;
a processor; and
a memory storing instructions to cause the processor to execute a method, comprising:
detecting that the user has attempted to dispose certain matter into the toilet;
detecting that the user has attempted to flush the toilet;
based on the industrial waste sensor, detecting that the certain matter being flushed includes industrial waste;
blocking the certain matter from being flushed into the sewage system;
allowing the certain matter to be flowed into the compartment in the toilet;
taking a picture of the user when the user is leaving the toilet room;
through the computer server, sending an alert to a third party to report the wrongful act, wherein the alert includes evidence of accusation of the wrongful act, the evidence including the picture of the user and the detected certain matter being flushed by the user;
allowing the third party to examine the contained subject matter by releasing the compartment in the toilet for examination;
allowing another user to use the toilet; and
if the another user is attempting to flush the toilet with non-industrial waste, allowing the non-industrial waste to be flushed into the sewage system.

2. The system of claim 1, wherein the method comprises:
detecting that the user has attempted to dispose certain matter into the toilet;
detecting that the user has attempted to flush the toilet;
based on the blockage sensor, detecting that the flow of water being flushed has slowed to a threshold point set previously;
concluding that the certain matter being flushed by the user causes the blockage;
blocking the certain matter from being flushed into the sewage system;
allowing the certain matter to be flowed into the compartment in the toilet;
taking a picture of the user when the user is leaving the toilet room;
through the computer server, sending an alert to a third party to report the wrongful act, wherein the alert includes evidence of accusation of the wrongful act, the evidence including the picture of the user and the detected certain matter being flushed by the user;
allowing the third party to examine the contained subject matter by releasing the compartment in the toilet for examination; and
allowing another user to use the toilet.

3. The system of claim 1, wherein the method comprises:
detecting that the user has attempted to dispose certain matter into the toilet;
detecting that the user has attempted to flush the toilet;
based on the blockage sensor, detecting that the flow of water being flushed has slowed to a threshold point set previously;
concluding that the certain matter being flushed by the user causes the blockage;
blocking the certain matter from being flushed into the sewage system;
allowing the certain matter to be flowed into the second compartment in the toilet;
taking a picture of the user when the user is leaving the toilet room;
through the computer server, sending an alert to a third party to report the wrongful act, wherein the alert includes evidence of accusation of the wrongful act, the evidence including the picture of the user and the detected certain matter being flushed by the user;
allowing the third party to examine the contained subject matter by releasing the second compartment in the toilet for examination;
detecting that a second user has attempted to dispose certain matter into the toilet;
detecting that the second user has attempted to flush the toilet;
based on the industrial waste sensor, detecting that the certain matter being flushed includes industrial waste;
blocking the certain matter from being flushed into the sewage system;
allowing the certain matter to be flowed into the compartment in the toilet;
taking a picture of the second user when the second user is leaving the toilet room;
through the computer server, sending an alert to a third party to report the wrongful act, wherein the alert includes evidence of accusation of the wrongful act, the evidence including the picture of the second user and the detected certain matter being flushed by the second user; and
allowing the third party to examine the contained subject matter by releasing the compartment in the toilet for examination.
